(19) United States
(12) Patent Application Publication
(10) Pub. No.: US 2026/0286581 A1
(43) Pub. Date: Sep. 24, 2026

(54) Flame Resistant Lining Fabric with Stretch Properties

(71) Applicant: Safety Components Fabric Technologies, Inc., Greenville, SC (US)

(72) Inventors: Jacques A. Cantin, Greenville, SC (US); Guy Connors Lucas, Charlotte, NC (US); Jamie Elizabeth Reid Sullivan, Whitsett, NC (US); Steven Glenn Webb, Burlington, NC (US); Elton Ray Lawrence, III, Rockingham, NC (US)

(21) Appl. No.: 19/573,378

(22) Filed: Mar. 20, 2026

Related U.S. Application Data
(60) Provisional application No. 63/775,552, filed on Mar. 21, 2025.

(51) Int. Cl. D03D 15/47; B32B 5/02; B32B 5/26; D03D 15/283; D03D 15/513

(52) U.S. Cl. CPC D03D 15/47; B32B 5/022; B32B 5/024; B32B 5/026; B32B 5/277; D03D 15/283; D03D 15/513; B32B 2250/20; B32B 2250/40; B32B 2262/0215; B32B 2262/0269; B32B 2262/128; B32B 2262/132; B32B 2307/3065; B32B 2307/51; B32B 2307/718; D10B 2331/021; D10B 2331/06; D10B 2331/12; D10B 2501/04

(57) ABSTRACT

A lining fabric for protective garments is disclosed. The lining fabric can be constructed to be flame resistant. The lining fabric is made from filament yarns and elastic spun yarns such that the resulting fabric has stretch in at least one direction.

### RELATED APPLICATIONS

The present application is based upon, and claims priority to, U.S. Provisional Patent Application Ser. No. 63/775,552 filed Mar. 21, 2025, which is incorporated herein by reference.

### BACKGROUND

Various different types of protective garments exist that are designed to protect the wearer in the environment in which the garment is worn. For instance, various protective garments exist that are intended to be fire resistant. Such garments are worn by military personnel, industrial workers, pilots, rescue personnel, and firefighters.

Firefighter garments, for instance, are intended to not only protect the firefighter from exposure to fires but are also designed to be water resistant. Firefighter garments typically include multiple layers of materials. For example, firefighter garments typically include an outer shell attached to an inner lining or face cloth. The firefighter garment may include intermediate layers, such as a moisture barrier layer and/or a thermal barrier layer. Each layer can be made from fire resistant materials, such as fire resistant fibers and yarns.

Many protective garments, such as firefighter garments, are intended not only to protect the wearer from fire and other elements, but the garments should also be comfortable to wear. For example, firefighter garments that do not provide water resistance may absorb water during use and increase in weight thereby increasing the load on the wearer.

The inner lining of protective garments as described above should also display high lubricity characteristics. A low friction inner lining, for instance, makes it much easier to don the garment and to take the garment off later. A low friction inner lining also can substantially increase the comfort of the garment during use, especially when the wearer is actively moving. Ultimately, a low friction inner lining can reduce the amount of stress imposed on the wearer, especially when worn in harsh environments.

In this regard, those skilled in the art in the past have attempted to produce inner linings for protective garments that are not only fire resistant but also have excellent lubricity characteristics. For example, inner linings made from multi-filament yarns and spun yarns are disclosed in U.S. Pat. No. 6,247,179, U.S. Pat. No. 5,858,888, and U.S. Patent Application Publication No. 20130205481 which are incorporated herein by reference. The inner linings disclosed in the above patents have provided great advancements in the art demonstrated by significant commercial success. U.S. Pat. No. 5,539,928, U.S. Pat. No. 11,337,473, U.S. Patent Publication No. 2016/0338433, and U.S. Patent Publication No. 2009/0255038, which are also incorporated herein by reference, also disclose inner liners having high lubricity characteristics.

The present disclosure is directed to further improvements in the construction of protective garments and particularly in the construction of liners for protective garments. In particular, the present disclosure is directed to liners that provide greater comfort to the wearer and facilitate movement of the wearer in the garment. The present disclosure is also directed to a composite fire resistant material that includes an improved lining fabric.

### SUMMARY

In general, the present disclosure is directed to a lining fabric and to a composite fire resistant material containing a lining fabric that possesses improved comfort characteristics. The lining and fabric of the present disclosure, for instance, can provide the wearer with greater flexibility and freedom of movement. The stretch characteristics of the lining fabric allow the material to move with the body making garments made with the fabric less restrictive, especially during activities like bending or stretching.

In one embodiment, for instance, the present disclosure is directed to a fire resistant material that comprises a lining fabric. The lining fabric includes first yarns woven together with second yarns. The first yarns extend in a first direction and the second yarns extend in a second direction. The first yarns comprise an elastic core surrounded by a sheath of inherently flame resistant fibers. The second yarns can comprise the same yarns as the first yarns or can comprise other types of flame resistant yarns. In one aspect, the second yarns can comprise inherently flame resistant filament yarns (which can include stretch broken filament yarns). In accordance with the present disclosure, the lining fabric displays a stretch of at least about 5% in at least the first direction and optionally in both directions. For instance, the lining fabric can display a stretch of greater than about 8%, such as greater than about 10%, such as greater than about 12% in at least the first direction or in both directions. The first direction can comprise the fill direction or the warp direction.

The elastic core of the first yarns can be comprised of any suitable elastomeric polymer. In one aspect, the elastic core can be comprised of a polyurethane polymer. In one particular embodiment, for instance, the elastic core can comprise spandex. The sheath of the first yarns, on the other hand, can comprise aramid fibers, such as para-aramid fibers, meta-aramid fibers, or mixtures thereof. In one embodiment, the sheath of the first fibers can further contain or exclusively contain flame resistant cellulose fibers. The flame resistant cellulose fibers can comprise, for instance, flame resistant viscose fibers, flame resistant rayon fibers, flame resistant regenerated cellulose fibers, flame resistant lyocell fibers, or mixtures thereof.

In one aspect, the sheath of the first yarns can be ring-spun. In one aspect, the first yarns comprise core-spun yarns. The first yarns can have a size of from about 18/1 to about 30/1 (e.g. 18/1, 20/1, 22/1, 24/1, 26/1, or the like).

The second yarns can comprise stretch yarns as described above, spun yarns, multi-filament yarns (including stretch broken yarns) or combinations thereof. The spun yarns and/or the filament yarns can be comprised of an aramid, such as a para-aramid, a meta-aramid, or mixtures thereof.

The lining fabric can have any suitable weave. For instance, the lining fabric can have a twill weave, a plain weave, or the like.

In one aspect, the fire resistant material of the present disclosure comprises a composite in which the lining fabric is quilted to an extensible thermal barrier layer. The thermal barrier layer, for instance, can be designed to stretch with the lining fabric. The thermal barrier layer, for instance, can be comprised of at least one nonwoven layer, such as two or more nonwoven layers. The fibers contained in the thermal barrier layer, such as the nonwoven layer, can comprise aramid fibers, such as para-aramid fibers, meta-aramid fibers, or mixtures thereof. The composite fire resistant material can have a basis weight of less than about 200 gsm, such as less than about 180 gsm, such as less than about 170 gsm, and greater than about 100 gsm, such as greater than about 120 gsm, such as greater than about 130 gsm, such as greater than about 140 gsm. In one aspect, the lining fabric and thermal barrier layer are quilted together according to a pattern. For instance, the pattern can be comprised of a repeating pattern of diamond-like shapes.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of one embodiment of a protective garment made in accordance with the present disclosure;

FIG. 2 is a plan view of one embodiment of an inner lining made in accordance with the present disclosure;

FIG. 3 is a cross-sectional view taken along lines 3-3 of FIG. 2;

FIG. 4 is a perspective view with cutaway portions of one embodiment of trousers made in accordance with the present disclosure;

FIG. 5 is a plan view of one embodiment of an inner lining quilting pattern made in accordance with the present disclosure;

FIG. 6 is a plan view of another embodiment of an inner lining quilting pattern made in accordance with the present disclosure; and

FIG. 7 is a plan view of still another embodiment of an inner lining quilting pattern made in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to protective garments that include an inner liner. The inner liner can comprise a single layer lining fabric or can comprise a composite fabric material in which the lining fabric defines one of the surfaces. Protective garments made according to the present disclosure can be flame resistant and can protect the wearer from exposure to fire, including flash fires. The inner liner can be constructed to not only be flame resistant but can also have high lubricity while providing comfort to the wearer. For example, in accordance with the present disclosure, the lining fabric of the present disclosure displays significant stretch properties in at least one direction.

For instance, lining fabrics made according to the present disclosure incorporate yarns that are not only elastic but are also flame resistant. Consequently, stretch can be incorporated into the fabric without compromising the flame resistant properties. The stretch properties of a fabric can be measured according to ASTM D3107-07R19 which determines the amount of fabric stretch, fabric growth and fabric recovery. Lining fabrics made according to the present disclosure, for instance, can display a stretch of at least about 5%, such as at least about 8%, such as at least about 10%, such as at least about 12%, and generally less than about 25%, such as less than about 20%, such as less than about 18% in at least one direction, such as in only one direction or in both directions. In one embodiment, the at least one direction is the fill direction. Stretch in the opposite direction, such as the warp direction, can be greater than about 1%, such as greater than about 3%, such as greater than about 5%, such as at least about 8%, such as at least about 10%, such as at least about 12%, and generally less than about 25%, such as less than about 20%, such as less than about 18%, such as less than about 15%, such as less than about 10%, such as less than about 8%. In one embodiment, the lining fabric can be produced with bi-directional stretch properties. For example, both the warp direction and the fill direction can display a stretch of greater than about 8%, such as greater than about 10%, and less than about 40%, such as less than about 25%, such as less than about 20%, such as less than about 15%.

The stretch incorporated into the fabric of the present disclosure is elastic and therefore recoverable. For instance, once stretched, the fabric can recover at least about 70%, such as at least about 80%, such as at least about 90%, such as at least about 95% in or both directions.

Incorporating stretch into the lining fabric of the present disclosure can provide numerous advantages and benefits. For instance, when incorporated into a garment and worn, the garment is less restrictive, especially during activities typically engaged by firefighters, such as bending, stretching, or the like. The lining fabric of the present disclosure can also conform to different body shapes and sizes, offering a more personalized and snug fit without feeling tight or binding. Fabrics with little to no stretch can create uncomfortable pressure points, especially in areas like the waist, elbows, or knees. The stretch lining fabric of the present disclosure, however, distributes tension more evenly, reducing discomfort. The lining fabric of the present disclosure is also recoverable and will return to its original shape after being pulled or worn, ensuring that the garment maintains its fit and does not become saggy over time. Overall, the fabric can feel softer to the wearer and can feel smooth against the skin.

In general, the lining fabric of the present disclosure is made from a woven fabric that includes at least at least one type of stretch yarn and in one embodiment can include at least two different types of yarns. The first yarn is an elastic spun yarn that may contain inherently flame resistant fibers, such as aramid fibers. In one aspect, the entire fabric is made from the elastic spun yarns. Alternatively, the fabric can include second yarns, which can comprise multi-filament yarns or spun yarns that can be made from flame resistant materials, such as FR treated materials and/or inherently flame resistant materials. In accordance with the present disclosure, the first yarns or spun yarns can contain an elastic core that makes the yarns elastic and stretchable.

In accordance with the present disclosure, the first yarns comprising the elastic spun yarns are woven with the optional second yarns comprising the multi-filament and/or spun yarns in a manner that produces a lining fabric with stretch properties, with high lubricity, and/or with excellent strength properties. In one aspect, for instance, the lining fabric is a woven fabric in which yarns are woven in a first direction, such as a fill direction, and in a second direction, such as a warp direction. The first direction can be comprised primarily or exclusively from the stretch spun yarns. The opposite or second direction, on the other hand, can be comprised primarily or exclusively from the stretch spun yarns or can primarily or exclusively comprise filament and/or spun yarns that do not contain an elastomeric material.

When the fabric contains stretch yarns in one direction and non-stretch or second yarns in an opposite direction, a weave can be used such that the filament or spun yarns (e.g. the non-stretch yarns) occupy a majority of the surface area on one surface of the lining fabric which then forms an interior surface of a protective garment. In this manner, the elastic spun yarns provide excellent stretch properties in at least one direction, such as the fill direction. The filament or spun yarns, however, not only provide strength but can also serve to create a fabric with high lubricity by remaining exposed on one side of the fabric. In one aspect, for instance, all of the fill yarns can comprise the spun elastic yarns while all of the warp yarns can comprise multi-filament yarns.

Alternatively, the first direction or fill direction of the fabric can include a combination of elastic spun yarns and filament and/or spun non-elastic yarns and/or the second direction or warp direction can comprise a combination of the elastic spun yarns and the filament and/or spun non-elastic yarns.

For instance, in one embodiment, the lining fabric includes non-elastic filament and/or spun yarns and elastic spun yarns that extend in the first direction, such as the fill direction. For example, the non-elastic filament and/or spun yarns and the elastic spun yarns can be present in the first direction in a number ratio of from about 1:1 to about 1:50. For instance, the number ratio between the non-elastic filament and/or spun yarns and the elastic spun yarns can be from 1:3 to about 1:20, such as from about 1:5 to about 1:15. The same ratios can exist in the second direction in one embodiment.

In an alternative embodiment, the ratio of the non-elastic filament and/or spun yarns to the elastic spun yarns can be as described above with respect to the first direction but can include a greater amount of non-elastic filament and/or spun yarns in the second direction or warp direction. For instance, the number ratio of the non-elastic filament and/or spun yarns to the elastic spun yarns in the second direction can be from about 1:1 to about 50:1, such as greater than about 2:1, such as greater than about 3:1, such as greater than about 4:1, such as greater than about 5:1, such as greater than about 6:1, such as greater than about 7:1, such as greater than about 8:1, such as greater than about 9:1, such as greater than about 10:1, and less than about 20:1, such as less than about 15:1, such as less than about 12:1.

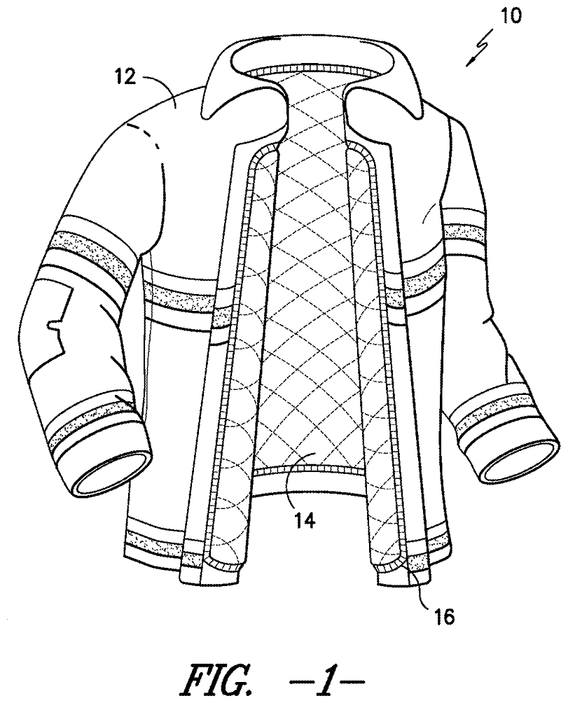

The lining fabric of the present disclosure can be used in numerous and diverse applications, especially where fire resistance is desired. The lining fabric can be used to line all different types of garments and articles of clothing, including hoods, hats, shirts, coats, pants, and the like. FIGS. 1 and 4 are provided for exemplary purposes only.

FIG. 1 illustrates an improved protective garment 10 constructed in accordance with the present disclosure. Garment 10 includes a relatively tough outer shell 12 having a liner assembly 14 located therein. Outer shell 12 and liner assembly 14 together function to protect a wearer from heat and flame such as may be encountered during firefighting activities.

Liner assembly 14 may be constructed as a separate unit that may be removed from outer shell 12. A zipper 16 is provided in this case to maintain liner assembly 14 in position within outer shell 12 as shown. It should be appreciated, however, that other suitable means of attachment, such as various hook and pile arrangements, may also be utilized for this purpose.

In an alternative embodiment, the liner can be permanently attached to the garment.

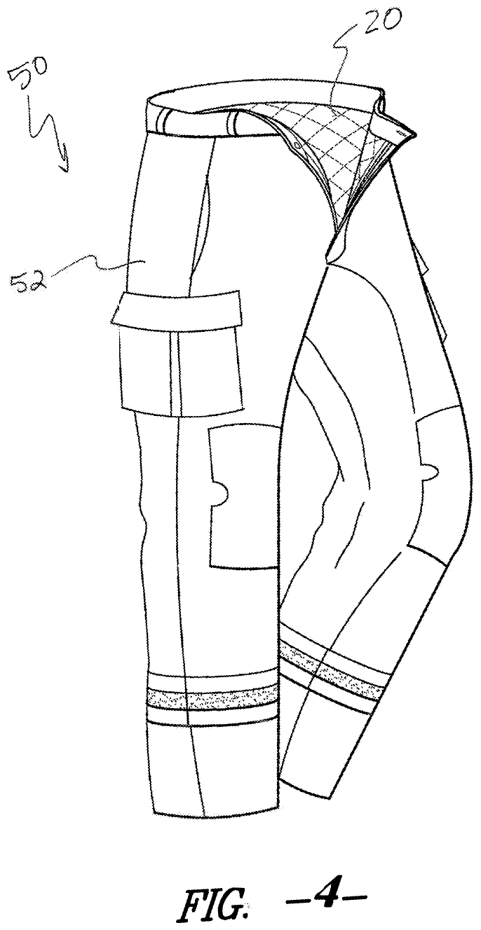

Referring to FIG. 3, one embodiment of a multi-layered garment in accordance with the present disclosure is shown. As shown, the garment includes a plurality of material layers quilted together by crisscrossing stitch lines 18. The stitch lines may hold together a thermal barrier layer 24, a moisture barrier layer 26, and a lining layer 20.

Typically, lining layer 20 will be adjacent the wearer's body during use. As will be described more fully below, lining layer or lining fabric 20 is made from a textile material having stretch, high lubricity and balanced properties. The higher lubricity characteristics make the surface of lining layer 14 relatively “slick.” This construction desirably reduces the friction that may otherwise be produced by rubbing against the wearer's clothing.

A thermal barrier layer 24 when combined with the lining fabric to form a composite can be made from any suitable extensible material that will allow the lining fabric to stretch. For instance, the thermal barrier layer 24 can be comprised of an extensible or stretchable nonwoven, woven, or knit fabric. The thermal barrier layer 24 can include a single layer of material or can include multiple layers of material. The thermal barrier layer 24 functions as an insulator to inhibit transfer of heat from the ambient environment to the wearer.

Similar to the thermal barrier layer 24, the moisture barrier layer 26 should also allow the lining fabric to stretch and can comprise an elastic film. Moisture barrier layer 26 is preferably a suitable polymeric membrane that is impermeable to liquid water but is permeable to water vapor. As such, exterior water (such as from a firefighter's water hose) will not penetrate the interior of garment 10, but perspiration from the firefighter can escape. Suitable membranes of this type are distributed by W. L. Gore & Associates under the trademark Gore-Tex.

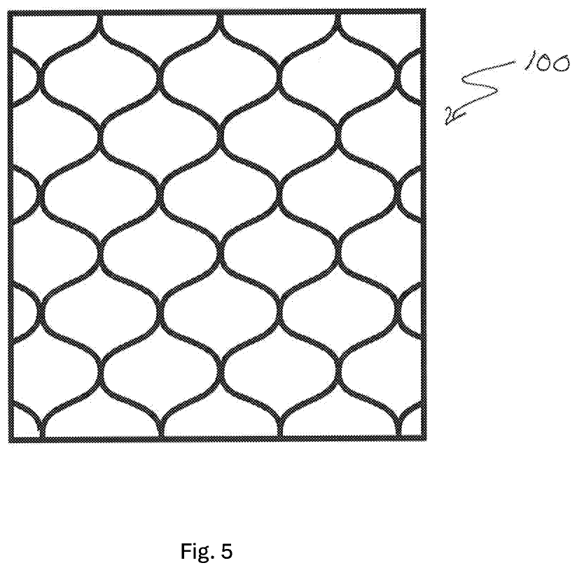

In addition to being used in coats and jackets as shown in FIG. 1, the lining layer of the present disclosure may also be used to line other garments. For instance, referring to FIG. 5, a pair of trousers made in accordance with the present disclosure is illustrated. As shown, the trousers 50 include an outer shell 52 similar to the outer shell 12 shown in FIG. 1. In addition, the trousers 50 include a lining layer 20 positioned to be adjacent the wearer's body during use.

As described above, the first yarns possess elasticity and, when incorporated into the lining fabric according to the present disclosure, can provide significant stretch in at least one direction. In one aspect, the spun yarns include an elastic core surrounded by a sheath of fibers that have been spun together. Placing a sheath of spun yarns around the core allows the yarn to stretch and retract without damaging the yarn. The elastic core of the spun yarns can comprise any suitable elastomer material. The core, for instance, can be comprised of an elastic monofilament or can comprise a plurality of elastic multi-filaments. In one aspect, the core is a monofilament fiber made from an elastic polymer. The elastic polymer can comprise any suitable elastic material that is compatible with the sheath of spun yarns and does not impair the flame resistant properties of the fabric. In one aspect, for instance, the elastic core can be made from a polyurethane polymer. Other polymers that can be used include various different types of elastomers, such as a silicone, or a polyolefin elastomer, such as a polypropylene or polyethylene random copolymer elastomer. In still another embodiment, the core can comprise spandex or elastane.

The sheath of fibers surrounding the elastic core can be made from fibers that are inherently flame resistant and/or fibers that are treated with a flame retardant composition. The flame resistant fibers can be used alone or in combination with other fibers, such as polyamide fibers. The spun sheath can be made exclusively from the same fiber or can be made from a blend of fibers.

In one aspect, the sheath is made from a single type of fiber, such as a single inherently flame resistant fiber. For example, the sheath can comprise para-aramid fibers or meta-aramid fibers. In still another embodiment, the sheath can be made exclusively from a flame retardant cellulose fiber.

In one embodiment, the sheath may be made from a blend of fibers. For instance, in one embodiment, the sheath may comprise meta-aramid fibers blended with para-aramid fibers. For instance, the para-aramid fibers may be present in an amount less than the meta-aramid fibers, such as in an amount less than about 15% by weight, such as from about 1% to about 15% by weight, such as from about 3% to about 10% by weight.

The sheath can contain the meta-aramid fibers in an amount greater than about 30% by weight, such as in an amount from about 30% by weight to about 100% by weight. The meta-aramid fibers may be present in the sheath in an amount greater than about 40% by weight, such as in an amount greater than 60% by weight, such as in an amount greater than about 80% by weight.

The meta-aramid fibers contained in the sheath can be substantially amorphous, crystalline, or a mixture of both. Amorphous meta-aramid fibers generally have a crystallinity of less than about 10%. Crystalline fibers, on the other hand, have a crystallinity greater than about 10%, such as greater than about 25%, such as having a crystallinity of from about 25% to about 40%.

In an alternative embodiment, instead of meta-aramid fibers, the sheath can contain primarily para-aramid fibers. For instance, the sheath can contain para-aramid fibers in an amount greater than 15% by weight, such as greater than about 30% by weight, such as greater than about 40% by weight, such as even greater than 60% by weight. In general, the sheath can contain para-aramid fibers in an amount up to 100% by weight, such as less than about 80% by weight, such as less than about 60% by weight.

In addition to meta-aramid fibers and/or para-aramid fibers, the sheath may contain various other inherently flame resistant fibers. Such fibers may include, for instance, polybenzimidazole fibers, such as poly[2,2′-(m-phenylen)-5,5′bibenzim idazole]. Polybenzimidazole fibers can be present in the sheath in an amount greater than 15% by weight, such as greater than about 30% by weight, such as greater than about 40% by weight, such as even greater than 60% by weight, and in an amount less than about 95% by weight, such as less than about 80% by weight, such as less than about 60% by weight.

In one aspect, the sheath can contain flame resistant cellulose fibers. As used herein, flame resistant cellulose fibers refers to cellulose fibers that have been treated with a flame resistant composition or flame retardant. The inclusion of cellulose fibers in the fiber blend can make the resulting fabric softer, more breathable, and less expensive. Examples of flame resistant cellulose fibers that may be incorporated into the fabric include FR cotton, FR rayon, FR acetate, FR triacetate, FR lyocell, and mixtures thereof. In one particular embodiment, FR rayon fibers are incorporated into the fiber blend. FR rayon fibers are available from various different sources. FR rayon fibers, for instance, are sold under the name LENZING by Lenzing Fibers of Austria. LENZING FR fibers are viscous fibers that have been treated with a flame retardant composition. In one embodiment, the flame resistant rayon fibers are made by spinning reconstituted cellulose from beech trees. Such fibers are more water absorbent than cotton fibers.

The amount of flame resistant cellulose fibers present in the sheath may depend upon various different factors and the particular application. In one embodiment, for instance, the flame resistant cellulose fibers may be present in the sheath in an amount from about 20% to about 100% by weight. In one particular embodiment, for instance, the flame resistant cellulose fibers may be present in the sheath in an amount from about 30% to about 50% by weight. In various different embodiments, the amount of flame resistant cellulose fibers present in the sheath can depend upon the amount of other fibers present and the type of fibers present. In general, flame resistant cellulose fibers may be present in the sheath in an amount greater than about 5% by weight, such as in an amount greater than 10% by weight, such as in an amount greater than 15% by weight, such as in an amount greater than 20% by weight, such as in an amount greater than 25% by weight, such as in an amount greater than 30% by weight, such as in an amount greater than 35% by weight, such as in an amount greater than 40% by weight, such as in an amount greater than 45% by weight, such as in an amount greater than 50% by weight, such as in an amount greater than 55% by weight, such as in an amount greater than 60% by weight, such as in an amount greater than 65% by weight, such as in an amount greater than 70% by weight, such as in an amount greater than 75% by weight, such as in an amount greater than 80% by weight. In one embodiment, the sheath may be made entirely from the flame resistant cellulose fibers. In general, however, the flame resistant cellulose fibers are generally present in an amount less than about 80% by weight, such as in an amount less than about 75% by weight, such as in an amount less than about 70% by weight, such as in an amount less than about 65% by weight, such as in an amount less than about 60% by weight, such as in an amount less than about 55% by weight, such as in an amount less than about 50% by weight, such as in an amount less than about 45% by weight, such as in an amount less than about 40% by weight, such as in an amount less than about 35% by weight, such as in an amount less than about 30% by weight, such as in an amount less than about 25% by weight, such as in an amount less than about 20% by weight, such as in an amount less than about 15% by weight.

As described above, flame resistant cellulose fibers comprise fibers that have been treated with a flame retardant composition. The flame retardant composition can be incorporated into the fibers using various methods and techniques. For instance, the flame retardant composition can be incorporated into the fibers during spinning, can be coated on the fibers, or can be absorbed into the fibers. The flame retardant composition may contain, for instance, a phosphorus compound, a halogen compound, or any other suitable flame resistant agents.

In still other embodiments, the sheath may contain synthetic fibers, such as polyamide fibers and/or polyester fibers. In one embodiment, the polyamide fibers and/or polyester fibers may contain or may be treated with a fire retardant. In one particular embodiment, the sheath can be contained in the fabric that contains a combination of aramid fibers, FR cellulose fibers, and polyamide fibers. The polyamide fibers may be present in an amount up to 20% by weight, such as in an amount from about 3% to about 15% by weight.

In one aspect, the sheath comprises a ring-spun sheath. For instance, the sheath fibers or blend of fibers can be spun around the elastic core using a ring-spinning method. Ring-spinning may provide various advantages. For instance, ring-spinning can create a smooth, fine, and strong outer or sheath layer.

In one embodiment, the first or elastic yarns can comprise core-spun yarns. It is believed that using a ring-spun sheath in a core-spun yarn provides resulting fabrics with a smooth surface and soft hand feel. The yarns are strong and resistant to pilling. In addition, core-spun yarns using a ring-spun sheath have bene found to have dimensional stability and are capable of holding their shape even after repeated wear and washing. In addition, the core-spun yarns provide the fabric with a high quality appearance.

The elastic spun yarns can have any suitable yarn size, as may be selected based on the desired properties of the resulting fabric or article. In certain embodiments, the spun yarns have a size of at least about 26/1. In broader aspects, the spun yarns can have a size of at least about 18/1, such as from about 18/1 to about 30/1, from about 18/1 to about 28/1, or from about 18/1 to about 26/1. In other embodiments, the spun yarns can have a size of from about 20/1 to about 26/1, or from about 22/1 to about 26/1. In still more particular embodiments, the spun yarns can have a size selected from the group consisting of 18/1, 20/1, 22/1, 24/1, and 26/1. In certain embodiments, the spun yarns have a size of about 26/1 or greater.

As described, the elastic spun yarns can optionally be combined with second yarns or non-elastic filament and/or spun yarns in accordance with the present disclosure.

In various embodiments, the non-elastic filament and/or spun yarns may comprise multifilament yarns or spun yarns containing aramid fibers, poly-p-phenylenebenzobisoxazole fibers (PBO fibers), polybenzimidazole (PBI) fibers, FR cellulose fibers, such as FR viscose filament fibers, synthetic fibers such as polyamide fibers, and mixtures thereof. In one embodiment, the non-elastic filament and/or spun yarns are made exclusively from inherently flame resistant fibers. For instance, the non-elastic filament and/or spun yarns may be made exclusively from para-aramid fibers or meta-aramid fibers. The use of para-aramid fibers and meta-aramid fibers can dramatically improve the strength properties of the fabric.

When incorporating para-aramid filament yarns into the fabric, the yarns may also be incorporated into the fabric having a minimal amount of twists. For example, filament yarns can be twisted less than five twists per inch, such as less than four twists per inch, such as even less than three twists per inch. In one embodiment, for instance, the filament yarns may not have any appreciable twisting. By not having to twist the filament yarns, the lubricity of the resulting fabrics can actually be enhanced in certain embodiments.

The fabric has excellent flame resistant properties. For instance, fabrics made in accordance with the present disclosure, even after being laundered five laundry cycles, can have a char length in a direction perpendicular to the filament yarns when tested according to ASTM Test D6413 (AATCC 135) of less than about 50 mm, such as less than about 40 mm, such as even less than about 30 mm. The char length, for instance, can be generally from about 5 mm to about 50 mm. In one particular embodiment, the char length in both directions can be less than about 15 mm.

The weight of the filament yarns can vary depending upon the particular application, the desired weight of the fabric, and various other factors. In general, the optional non-elastic yarns can have a weight of greater than about 100 denier, such as greater than about 140 denier, such as greater than about 180 denier. The denier of the non-elastic yarns is generally less than about 500 denier, such as less than about 400 denier. In one embodiment, the non-elastic yarns have a denier of from about 150 to about 250, such as from about 180 to about 220.

In general, the elastic spun yarns and non-elastic yarns are woven together such that the non-elastic yarns comprise more than about 50% of the surface area of one side of the fabric, such as both sides of the fabric. For instance, the non-elastic yarns may comprise greater than about 60%, such as greater than about 70%, such as even greater than about 80% of each side of the fabric. The non-elastic yarns can provide a fabric with high lubricity characteristics.

In one embodiment, the warp yarns and the fill yarns are woven together using a twill weave.

In another embodiment, warp yarns and fill yarns are woven together utilizing a satin weave in order to achieve the desirable qualities discussed above. In a satin weave, the interlacing of each warp yarn is at least one fill yarn apart from the interlacing of either of the two warp yarns next to it. The points of interlacing do not produce an unbroken line (such as with a twill weave), but are scattered about over the weave. The interlacings of the warp yarns are thus hidden by adjacent floats.

In still another embodiment, the lining fabric can have a plain weave. A plain weave, for instance, may provide for greater stretch properties.

In general, the lining fabric of the present disclosure may be treated with various finishes. In one particular embodiment, for instance, the fabric may be treated with an anti-odor agent. For instance, the anti-odor agent may comprise metal ions, such as silver ions. The silver ions may act as an antimicrobial agent for reducing odors. In one embodiment, the silver ions may be present in a compound or complex that also absorbs odors. For instance, in one embodiment, the silver ions may be present in a porous zeolite.

In one embodiment, the fabric of the present disclosure may be powder coated with an anti-odor agent. For instance, the anti-odor agent may be in the form of particles having a size of less than about 1 micron, such as from about 0.001 microns to about 1 micron. The anti-odor agent may be combined with a pre-polymer or polymer. The resulting particles may then be heated and applied to the fabric. The polymer or pre-polymer forms an attachment to the surface. The polymer or pre-polymer may comprise a thermoplastic polymer or a thermosetting polymer. The polymer may comprise, for instance, polyester resins, epoxy resins, acrylic resins, phenol resins, melamine resins, urea resins, urethane resins, vinylether resins, and the like. Other polymers include polyamides, polymethylmethacrylate, and polyolefins.

In an alternative embodiment, the anti-odor agent may be contained in a finish that is then applied to the fabric. The finish may include binders, leveling agents, adherents, thickeners, and the like. For instance, in one embodiment, a binder, such as a polyurethane or an acrylic-type resin may be combined with the anti-odor agent and applied to the fabric as a liquid. Once applied, the fabric may be dried.

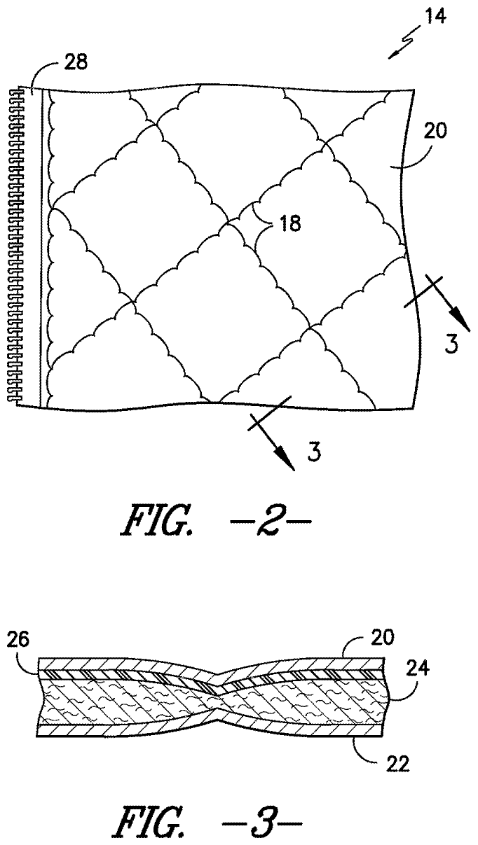

As described above and shown in FIGS. 2 and 3, in one embodiment, the fire resistant material of the present disclosure comprises the lining fabric quilted to other layers, such as the thermal barrier layer 24. In accordance with the present disclosure, the thermal barrier layer 24 is extensible in order to allow the lining fabric to stretch and contract. The thermal barrier layer 24 can be made from inherently flame resistant fibers, flame retardant cellulose fibers, or mixtures thereof. In one embodiment, the thermal barrier layer 24 comprises one or more nonwoven webs. For instance, the nonwoven webs can be bonded and/or carded webs that provide void space within the garment, or flame resistance, and can be extended in one or more directions when the lining fabric is stretched. In one aspect, for instance, the thermal barrier layer 24 comprises a batting made from aramid fibers, such as meta-aramid fibers, para-aramid fibers, or mixtures thereof.

In one aspect, the thermal barrier layer 26 can include one or more fabric layers, such as one or more nonwoven webs combined with an elastic fabric or film. By incorporating an elastic fabric or film into the thermal barrier layer 24, the thermal barrier layer 24 will retract when the liner fabric is stretched and retracted. For instance, the thermal barrier layer 24 can comprise a stretch bonded laminate or a neck bonded laminate.

The thermal barrier layer 24 is attached to the lining fabric in a way that allows both layers to stretch and optionally retract. As shown in FIG. 2, for instance, in one embodiment, the fabrics can be quilted together using a diamond-like pattern. In one aspect, the quilted effect is minimized in order to allow for maximum stretch potential, especially with respect to the filling yarns. For example, when the individual components are brought together for quilting, the stitching and pattern can be optimized for maintaining the stretch and integrity of the composite. This can be done by allowing the filling yarns maximum movement in the filling direction.

FIGS. 5 through 7 show various quilting patterns that can be incorporated into the stretchable composite fabric of the present disclosure. FIG. 5 illustrates a quilting pattern 100 comprised of interconnected onion-shaped figures. Each pattern figure comprises a horizontally oriented, onion-shaped form with a smoothly curved perimeter. This unique shape is defined by a broad, rounded middle that gradually tapers to a narrower top and bottom, creating a structured appearance. The design allows for efficient pattern repetition and alignment.

The quilt pattern figure can be constructed within defined dimensional constraints to maintain aesthetic and structural integrity. The height of the figure can range from approximately two inches to four inches, while the width varies between five inches and seven inches. These proportions establish an aspect ratio between 2.5:1 and 1.75:1, ensuring a balanced and visually appealing design. The shape's curvature can be derived from a superellipse.

The figures may be arranged in a tessellating or staggered manner, allowing for a continuous flow of design elements. Additionally, the contours of the shape may be emphasized through quilting stitches that follow the perimeter, enhancing texture and dimensionality. Due to its horizontally oriented structure and curved edges, the pattern also enhances stretch in the filling direction (weft direction in woven fabrics). The arrangement of the shapes facilitates controlled expansion and contraction, distributing fabric tension more evenly across the quilt surface. This property is particularly beneficial for stretch composites without compromising structural integrity.

This quilt pattern 100 as shown in FIG. 5 provides multiple advantages. Its distinctive shape enhances visual interest while maintaining a high degree of adaptability. The controlled geometry ensures that the pattern can be easily replicated while maintaining aesthetic coherence. Furthermore, the well-defined mathematical basis of the design allows for precise scaling, making it suitable for a wide range of fabric sizes and quilting techniques. The added benefit of enhanced stretch in the filling direction contributes to greater comfort, durability, and flexibility.

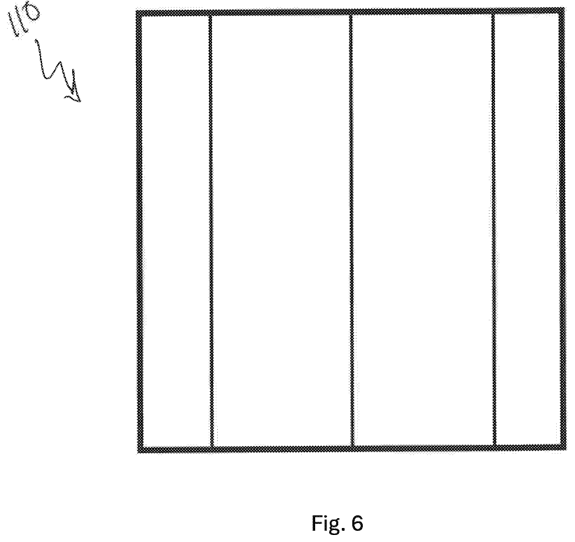

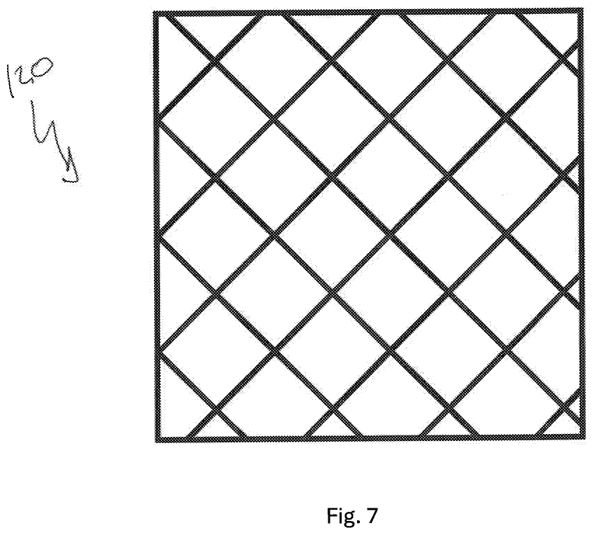

Another quilting pattern 110 is shown in FIG. 6, which can be referred to as a channel pattern. The quilting pattern 110 is comprised of vertical and parallel stitch lines. The stitch lines can be equally or unequally spaced apart. The stitch lines can be spaced in one half inch to 8 inch increments. In one aspect, the pattern can include lines spaced between one half inch to about 1.5 inches apart in combination with lines between about 3 inches to about 6 inches apart for varied spacing between channels. This pattern can provide excellent stretch characteristics.

FIG. 7 illustrates another version of a diamond pattern 120. In this embodiment, all four sides of the diamond are equal length for consistent spacing and fill within the pattern.

The basis weight of the lining fabric can depend upon various factors including the type of protective garment being formed and whether the lining fabric is to be contained in a composite fabric material. In one aspect, the lining fabric has a basis weight of greater than about 70 gsm, such as greater than about 100 gsm, such as greater than about 115 gsm, and less than about 170 gsm, such as less than about 150 gsm, such as less than about 135 gsm. When combined with a thermal barrier layer as shown in FIG. 3, the resulting fire resistant composite material can have a basis weight of less than about 250 gsm, such as less than about 225 gsm, such as less than about 200 gsm, such as less than about 180 gsm, and greater than about 140 gsm, such as greater than about 150 gsm.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A fire resistant material comprising:
a lining fabric comprised of first yarns optionally woven together with second yarns, the first yarns extending in a first direction and the optional second yarns extending in a second direction, the first yarns comprising an elastic core surrounded by a sheath of flame resistant fibers, the optional second yarns comprising flame resistant yarns; and
wherein the lining fabric displays a stretch of at least about 5% in the first direction.

2. A fire resistant material as defined in claim 1, wherein the lining fabric displays a stretch of at least about 8% in the first direction.

3. A fire resistant material as defined in claim 1, wherein the first yarns comprise fill yarns and the second yarns are present in the lining fabric and comprise warp yarns.

4. A fire resistant material as defined in claim 1, wherein the elastic core of the first yarns comprises spandex.

5. A fire resistant material as defined in claim 1, wherein the sheath of the first yarns is comprised of aramid fibers, flame resistant cellulose fibers, or mixtures thereof.

6. A fire resistant material as defined in claim 1, wherein the sheath of the first yarns is comprised of meta-aramid fibers blended with flame resistant viscose fibers, flame resistant regenerated cellulose fibers, or flame resistant lyocell fibers.

7. A fire resistant material as defined in claim 1, wherein the sheath of the first yarns comprises ring-spun fibers.

8. A fire resistant material as defined in claim 1, wherein the first yarns comprise core-spun fibers.

9. A fire resistant material as defined in claim 1, wherein the first yarns have a fiber size of from about 18/1 to about 30/1.

10. A fire resistant material as defined in claim 1, wherein the lining fabric has a basis weight of from about 3 osy to about 5 osy, such as from about 3.5 osy to about 4.5 osy.

11. A fire resistant material as defined in claim 1, wherein the second yarns are present in the lining fabric and comprise filament yarns.

12. A fire resistant material as defined in claim 1, wherein the second yarns are present in the lining fabric and comprise inherently flame resistant fibers.

13. A fire resistant material as defined in claim 1, wherein the second yarns are present in the lining fabric and comprise para-aramid fibers, meta-aramid fibers, or mixtures thereof.

14. A fire resistant material as defined in claim 1, wherein the lining fabric is formed from a twill weave.

15. A fire resistant material as defined in claim 1, further comprising an extensible thermal barrier layer attached to the lining fabric and wherein the extensible barrier layer comprises at least one nonwoven layer or comprises at least one knit fabric layer.

16. A fire resistant material as defined in claim 15, wherein the thermal barrier layer comprises a woven layer or a knit fabric layer positioned between at least two nonwoven layers and wherein the thermal barrier layer comprises inherently flame resistant fibers.

17. A fire resistant material as defined in claim 15, wherein the lining fabric and the thermal barrier layer are quilted together.

18. A fire resistant material as defined in claim 15, wherein the liner fabric and thermal barrier layer together have a basis weight of less than about 200 gsm and greater than about 100 gsm.

19. A fire resistant material as defined in any of claims 15, wherein the extensible barrier layer comprises a mixture of meta-aramid fibers and para-aramid fibers.

20. A fire resistant material as defined in claim 17, wherein the lining fabric and the thermal barrier layer are quilted together in a quilted pattern, the quilted pattern comprising diamond-like shapes or onion-like shapes.

21. A fire resistant material as defined in claim 1, wherein the lining fabric displays a stretch of at least about 8% in the first direction and in the second direction.

22. A fire resistant material as defined in claim 1, wherein the first yarns extend in the first direction and in the second direction.
